(19) United States
(12) Patent Application Publication
(10) Pub. No.: US 2026/0093289 A1
(43) Pub. Date: Apr. 2, 2026

(54) DOCKING STATION

(71) Applicant: Anker Innovations Technology Co., Ltd., CHANGSHA (CN)

(72) Inventors: Jingxiu WU, CHANGSHA (CN); Jiancheng SONG, CHANGSHA (CN)

(73) Assignee: Anker Innovations Technology Co., Ltd., CHANGSHA (CN)

(21) Appl. No.: 19/328,269

(22) Filed: Sep. 15, 2025

(30) Foreign Application Priority Data
Sep. 30, 2024 (CN) 202422406671.X

(51) Int. Cl. G06F 1/16; G06F 1/26

(52) U.S. Cl. CPC G06F 1/1677; G06F 1/1632; G06F 1/1698; G06F 1/266

(57) ABSTRACT

A docking station includes a housing. A rotation detection device, which is electrically connected to a processing device, is disposed inside the housing. The processing device is electrically connected to a display device. During using the docking station, rotating the docking station can be detected by the rotation detection device. In this case, the rotation detection device collects a rotation state parameter related to rotation of the docking station, and sends the rotation state parameter to the processing device. After receiving the rotation state parameter, the processing device analyzes to obtain a display adjustment signal. The display adjustment signal is configured to adjust display content of the display device when rotating the docking station. The display device adjusts the display angle of its display content according to the rotation angle of the display content carried by the display adjustment signal.

### CROSS-REFERENCE TO RELATED APPLICATIONS

The present application claims priority to Chinese Patent Application No. 202422406671.X, filed on Sep. 30, 2024, which is herein incorporated by reference in its entirety.

### TECHNICAL FIELD

The present disclosure relates to the field of electronic technologies, and in particular to a docking station.

### BACKGROUND

A docking station (dock), also known as a port replicator, is an external device designed specifically for a laptop computer. The laptop computer is able to be connected to multiple peripherals or external devices by replicating or expanding ports of the laptop computer using the docking station. In order to meet diverse needs of a user, a liquid crystal display (LCD) is usually disposed on a surface of the docking station.

However, in related art, a display direction of a fixed display screen on the docking station is fixed. In cases where the user uses the docking station in various scenarios, it is difficult for the user to view relevant information of a connection interface displayed on the display screen of the docking station.

### SUMMARY OF THE DISCLOSURE

The present disclosure provides a docking station including a housing, at least one interface assembly, a rotation detection device, a processing device, and a display device. An outer surface of the housing defines at least one expansion port. At least one interface assembly is disposed inside the housing, there is a one-to-one correspondence between the at least one interface assembly and the at least one expansion port, and an interface end of each interface assembly extends to one corresponding expansion port. The rotation detection device is disposed inside the housing and configured to obtain a rotation state parameter of the docking station when rotating the docking station. The processing device is disposed inside the housing and electrically connected to the rotation detection device, the processing device is configured to receive the rotation state parameter and to output a display adjustment signal, the display adjustment signal is determined based on the rotation state parameter, the display adjustment signal includes a rotation angle of display content, and rotation angles of the display content corresponding to different rotation state parameters are different. The display device is disposed inside the housing, a part of the display device is exposed on the outer surface of the housing, the display device is electrically connected to the processing device, and the display device is configured to adjust a display angle of the display content based on the display adjustment signal.

### BRIEF DESCRIPTION OF THE DRAWINGS

In order to more clearly illustrate technical solutions in some embodiments of the present disclosure or in the related art, hereinafter, the accompanying drawings that are used in the description of some embodiments or the related art will be briefly described. Obviously, the accompanying drawings in the description below are merely the accompanying drawings in some embodiments of the present disclosure. For those of ordinary skill in the art, other accompanying drawings may be obtained based on these accompanying drawings without any creative efforts.

FIG. 1 is a structural schematic view of a docking station in some embodiments of the present disclosure.

FIG. 2 is a structural schematic view of a docking station in some embodiments of the present disclosure.

FIG. 3 is a structural schematic view of a docking station in some embodiments of the present disclosure.

FIG. 4 is a structural schematic view of a docking station in some embodiments of the present disclosure.

FIG. 5 is a structural schematic view of a docking station in some embodiments of the present disclosure.

FIG. 6 is a circuit structural schematic view of a low-dropout regulator in some embodiments of the present disclosure.

FIG. 7 is a circuit structural schematic view of MPU-6050 in some embodiments of the present disclosure.

FIG. 8 is a structural schematic view of an integrated circuit bus communication module in some embodiments of the present disclosure.

### DETAILED DESCRIPTION

In order to facilitate understanding of the present disclosure, a more comprehensive description of the present disclosure will be provided below with reference to relevant accompanying drawings. The preferred embodiments of the present disclosure are shown in the accompanying drawings. However, the present disclosure can be implemented in many different forms and is not limited to the embodiments described herein. On the contrary, a purpose of providing these embodiments is to provide a more thorough and comprehensive understanding of content of the present disclosure.

The present disclosure provides a docking station that can improve convenience for a user to view information during using the docking station.

The docking station in the present disclosure is a type of docking station that is provided with a display device. A device state, data information, or content such as an image and a video can be intuitively viewed through the display device. A type of the display device configured in the docking station is not intended to be limiting. The display device may be a liquid crystal display (LCD), a light emitting diode (LED) display screen, an organic light emitting diode (OLED) display screen, etc., which are not specifically limited. In order to facilitate understanding of technical solutions of the present disclosure, the following embodiments take the display device being an LCD as an example.

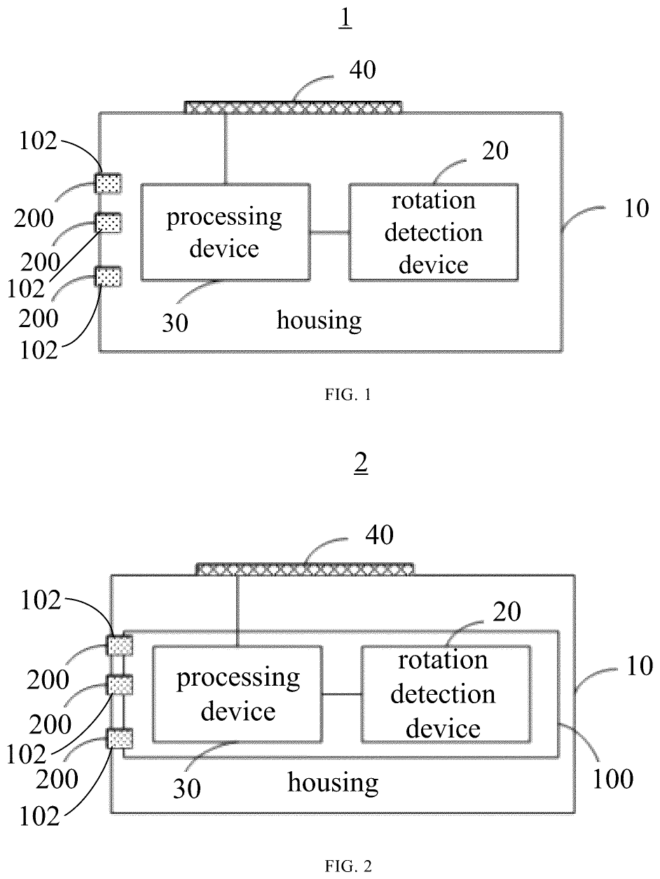

Referring to FIG. 1, the present disclosure provides a docking station 1. The docking station 1 includes at least one interface assembly 200, a housing 10, a rotation detection device 20, a processing device 30, and a display device 40. An outer surface of the housing 10 defines at least one expansion port 102. The docking station 1 may include one interface assembly 200 or multiple interface assemblies 200. FIG. 1 illustrates an example where the docking station 1 includes three interface assemblies 200. The interface assemblies 200 are disposed inside the housing 10, and an interface end of each interface assembly 200 extends to one corresponding expansion port 102. Referring to FIG. 1, the docking station 1 includes three expansion ports 102, there is a one-to-one correspondence between the three interface assemblies 200 and the three expansion ports 102, so that each expansion port 102 is connected to the corresponding interface assembly 200.

The rotation detection device 20 is disposed inside the housing 10. The rotation detection device 20 is configured to obtain a rotation state parameter of the docking station 1 in a case where the docking station 1 is rotated. The processing device 30 is disposed inside the housing 10, and the processing device 30 is electrically connected to the rotation detection device 20. The processing device 30 is configured to receive the rotation state parameter and to output a display adjustment signal. The display adjustment signal is determined based on the rotation state parameter. The display adjustment signal includes a rotation angle of display content. The rotation angles of the display content corresponding to different rotation state parameters are not the same. The display device 40 is disposed inside the housing 10, and a part of the display device 40 is exposed on the outer surface of the housing 10. The display device 40 is electrically connected to the processing device 30, and the display device 40 is configured to adjust the display angle of the display content according to the display adjustment signal.

In some embodiments, the housing 10, also known as an outer shell of the docking station 1, is configured to accommodate and support other components of the docking station 1, while also providing protection. The interface assembly 200 is a device that is configured to implement an interface extension function. The rotation detection device 20, which is disposed inside the housing 10, is capable of following changes in positions and postures of the docking station 1 in different usage scenarios. This causes the rotation detection device 20 own parameter to change, thereby detecting a rotation state of the docking station 1. The processing device 30 is a device that has a data transceiver function and a data processing function. The display device 40 is a device that is configured to display a state of a connection device of the docking station 1, data information of an interface connection, or the content such as the image and the video. The display device 40 may be the liquid crystal display screen, etc.

The rotation state parameter represents a real-time position parameter of the docking station 1 that is collected by the rotation detection device 20 in a case where the docking station 1 is rotated. The type of the rotation state parameter is not intended to be limiting. The rotation state parameter may vary depending on the type of rotation detection device 20. In some embodiments, the rotation state parameter may be spatial position coordinate data that is collected by the rotation detection device 20. In a case where the docking station 1 is rotated, in order to facilitate the user viewing the display content of the display device 40, the display adjustment signal carries parameters such as the rotation angle that needs to be adjusted for the display content.

During using the docking station 1, the rotation detection device 20 detects rotation of the docking station 1 in real-time. The rotation of the docking station 1 may cause a change in spatial position. The rotation detection device 20 detects this change, obtains the rotation state parameter, and sends the rotation state parameter to the processing device 30. After receiving the rotation state parameter, the processing device 30 analyzes in conjunction with the rotation state parameter, and finally determines the current state of the docking station 1 relative to its original horizontal placement and the display adjustment signal that is required by the processing device 30. The processing device 30 sends the display adjustment signal to the display device 40, so that the display device 40 rotates or adjusts the display angle of the display content.

Magnitude of the rotation angle of the display content is not intended to be limiting, and the rotation angle of the display content is not limited to conversion between landscape display and portrait display. In some embodiments, the rotation angle of the display content is greater than 0 degrees and less than or equal to 360 degrees. That is, the display content of the display device 40 may be adjusted from 0 degrees to 360 degrees based on an initial display direction, thereby meeting needs of various combination placement scenarios for the docking station 1. The present disclosure does not limit the initial display direction. The initial display direction may be a horizontal landscape display direction or a horizontal portrait display direction, or a direction that forms a certain angle with the horizontal landscape display direction.

In addition, according to common observation habits of people, the display content is usually presented in a way that conforms to visual and reading habits. That is, the display content should be as parallel to a horizontal plane as possible, which is not limited in the present disclosure.

In some embodiments, the processing device 30 determines the display adjustment signal based on the rotation state parameter, which includes: determining a posture change parameter based on the rotation state parameter; analyzing according to the posture change parameter to determine the display adjustment signal. The posture change parameter represents spatial position change amount that is caused by the rotation of the docking station 1, that is, the posture change parameter represents posture change amount.

In some embodiments, after receiving the rotation state parameter, the processing device 30 may determine whether the rotation state parameter is received normally. In a case where it determines that the rotation state parameter is received normally, the processing device 30 determines the posture change parameter based on the rotation state parameter.

A method for determining whether the rotation state parameter is received normally is not intended to be limiting. In some embodiments, determining whether the rotation state parameter is received normally may be achieved by verifying address carried by the rotation state parameter and verifying a data range where the rotation state parameter is located. In some embodiments, in a case where it verifies that the address carried by the rotation state parameter is normal and a numerical range of the rotation state parameter is within a preset range, it is considered that the rotation state parameter is received normally.

In a case where the rotation state parameter is not received normally, collection of the rotation state parameter is repeated until the rotation state parameter is received normally.

In some embodiments, in a case where the rotation state parameter is not received normally multiple times, a prompt signal may further be output. The prompt signal is configured to alert the user that data is not received normally.

In some embodiments, the processing device 30 may be a main controller configured for interface expansion in the docking station 1. That is, display processing and interface expansion of the docking station 1 share one device. In this way, it can not only save equipment costs but also reduce equipment volume.

In some embodiments, the processing device 30 may also be a separate device, independent of the main controller of the docking station 1. That is, the interface expansion and display processing of the docking station 1 are implemented using different devices. In this way, it effectively alleviates data processing load of the main controller of the docking station 1, thereby improving operating efficiency of the docking station 1.

In order to facilitate understanding of the technical solutions of the present disclosure, the following embodiments are explained and illustrated using an example of the display processing and the interface extension sharing one device. The specific type of the processing device 30 is not intended to be limiting. In some embodiments, the processing device 30 may be a microcontroller unit (MCU), a central processing unit (CPU), or a single-chip microcomputer, etc., which is not limited in the present disclosure.

In the docking station 1 described above, the rotation detection device 20, which is electrically connected to the processing device 30, is disposed inside the housing 10. The processing device 30 is further electrically connected to the display device 40. During using the docking station 1 by the user, in a case where the spatial position of the docking station 1 changes by rotating the docking station 1 relative to a previous time period or moment, this change can be detected by the rotation detection device 20. In this case, the rotation detection device 20 collects the rotation state parameter related to the rotation of the docking station 1, and sends the rotation state parameter to the processing device 30. After receiving the rotation state parameter, the processing device 30 analyzes to obtain the display adjustment signal. The display adjustment signal is a signal that is configured to adjust the display content of the display device 40 in a case where the docking station 1 is in a rotated state, making it easier for the user to view the display content. Finally, the display device 40 adjusts the display angle of its display content according to the rotation angle of the display content carried by the display adjustment signal. Therefore, during using the docking station 1 by the user in multiple scenarios, the display content on the docking station 1 can adapt to common observation habits of people, facilitating the user viewing the display content. Through this solution, in a case where the user rotates the docking station 1 from multiple angles during using the docking station 1, the display content on the docking station 1 can adapt to real-time changes caused by the rotation of the docking station 1, thereby effectively improving convenience of information viewing during using the docking station 1.

The method in which the interface assembly 200, the rotation detection device 20, and the processing device 30 are disposed inside the housing 10 is not intended to be limiting. In some embodiments, the interface assembly 200, the rotation detection device 20, and the processing device 30 may be in direct contact with the housing 10 and disposed on an inner surface of the housing 10. The electrical connections between the devices that need to be electrically connected may be achieved through wiring.

In some embodiments, referring to FIG. 2, a docking station 2 further includes a circuit board 100 that may be disposed inside the housing 10. The interface assembly 200, the rotation detection device 20, and the processing device 30 may all be disposed on the circuit board 100, or connected to the circuit board 100. The electrical connections between the devices may be achieved through wiring on the circuit board 100. A first communication device, a second communication device, and a low-dropout regulator involved in the following embodiments may also be electrically connected to the circuit board 100 or disposed on the circuit board 100 in a similar manner, which are not further described.

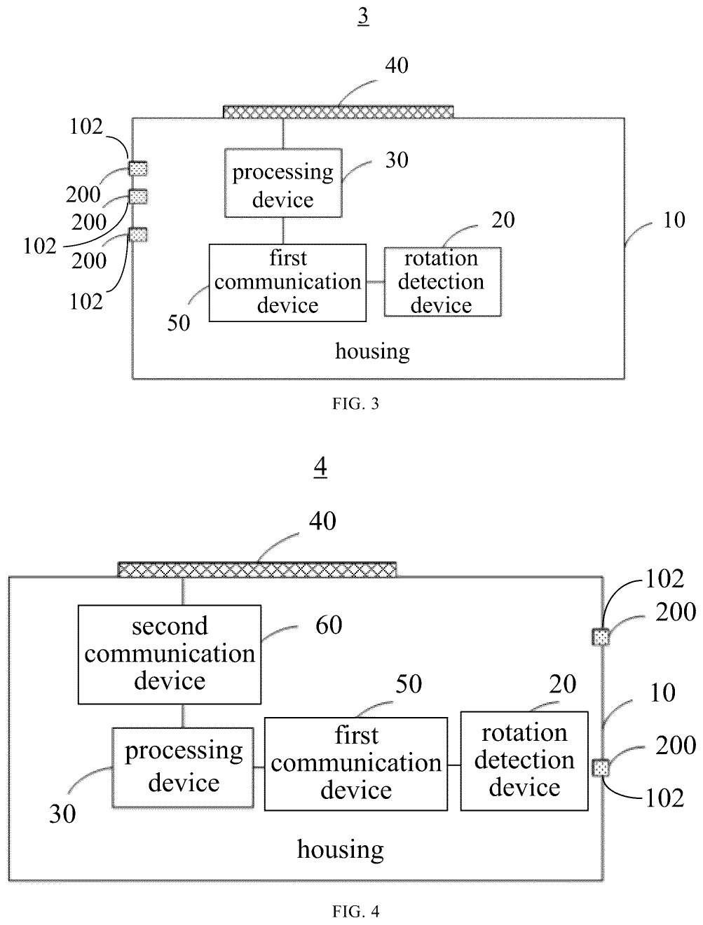

Referring to FIG. 3, in some embodiments, a docking station 3 further includes a first communication device 50 that is disposed inside the housing 10. The rotation detection device 20 is electrically connected to the processing device 30 through the first communication device 50.

In some embodiments, the first communication device 50 is configured to achieve communication between the rotation detection device 20 and the processing device 30. In an actual detection scenario, a communication protocol between the rotation detection device 20 and the processing device 30 may not be consistent. In order to achieve reliable transmission of the rotation state parameter, the first communication device 50 needs to be disposed between the rotation detection device 20 and the processing device 30. The protocol conversion is performed through the first communication device 50, thereby improving transmission reliability of the rotation state parameter.

A type of the first communication device 50 is not intended to be limiting, and may vary depending on the type of the rotation detection device 20 or the type of the processing device 30. In some embodiments, the first communication device 50 may be an inter-integrated circuit (IIC) communication module.

In some embodiments, the IIC communication module is also known as an I2C communication module. That is, the IIC communication module is a communication module that uses an IIC communication protocol for data transmission. In some embodiments, the rotation detection device 20 communicates with the processing device 30 through an SDA pin and an SCL pin of the IIC communication module, providing the real-time rotation state parameter. In this solution, the IIC communication module is adopted as the first communication device 50, which can achieve both low-speed and high-speed data transmission and has strong universality.

Referring to FIG. 4, in some embodiments, a docking station 4 further includes a second communication device 60 that is disposed inside the housing 10. The processing device 30 is electrically connected to the display device 40 through the second communication device 60.

In some embodiments, the second communication device 60 is configured to achieve communication between the display device 40 and the processing device 30. In the actual detection scenario, there may be a communication protocol mismatch between the display device 40 and the processing device 30. In order to achieve reliable transmission of the display adjustment signal, the second communication device 60 needs to be disposed between the display device 40 and the processing device 30. The protocol conversion can be performed through the second communication device 60, thereby improving transmission reliability of the display adjustment signal.

A type of the second communication device 60 is not intended to be limiting and may be disposed to be the same as or different from the type of the first communication device 50. In some embodiments, the second communication device 60 may vary depending on the type of the display device 40 or the type of the processing device 30, which is not limited in the present disclosure. In some embodiments, the second communication device 60 may be a serial peripheral interface (SPI) communication module or a mobile industry processor interface (MIPI) communication module.

In some embodiments, the SPI communication module is a communication module that uses a SPI protocol for data transmission. The MIPI communication module is a communication module that uses a MIPI protocol for data transmission. The SPI communication module transmits and controls data through four signal lines (SCLK, MOSI, MISO, CS), which has the advantages of strong flexibility and adjustable speed. The MIPI communication module supports high-speed serial data transmission, meeting performance requirements of the docking station 4. The MIPI communication module can be extended to higher data transmission rates and is more suitable for a high-resolution LCD. In an actual scenario, a specific communication module configured to achieve communication between the processing device 30 and the display device 40 is not limited in the present disclosure.

In some embodiments, the second communication device 60 may also be an RS-232 communication module, an RS-485 communication module, a low-voltage differential signaling (LVDS) communication module, etc. The second communication device 60 can be selected based on the actual scenario.

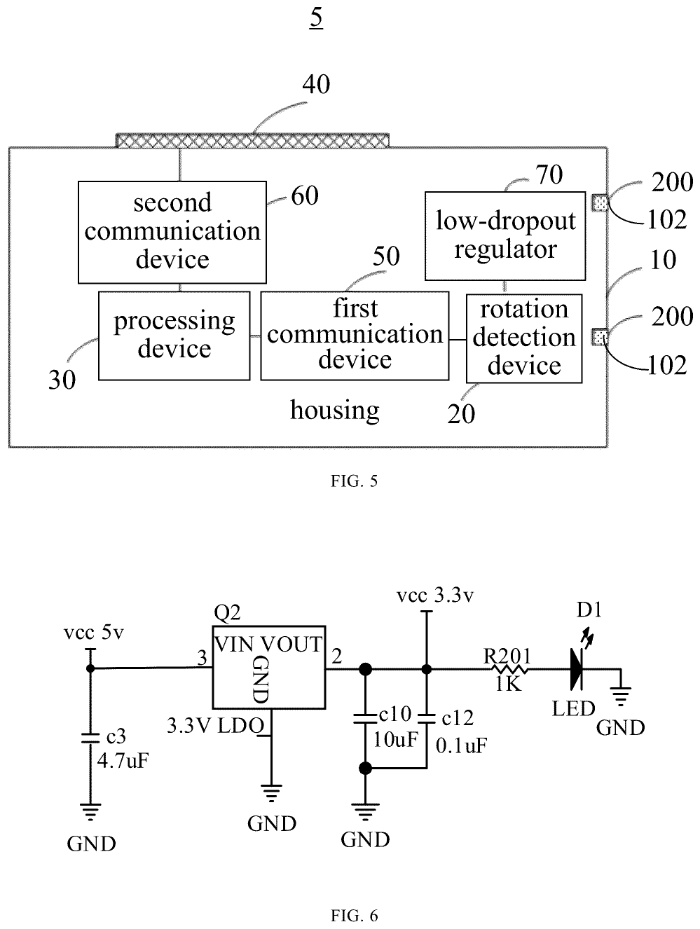

Referring to FIG. 5, in some embodiments, a docking station 5 further includes a low-dropout regulator (LDO) 70 that is disposed inside the housing 10. The low-dropout regulator 70 is electrically connected to the rotation detection device 20. The low-dropout regulator 70 is configured to be connected to an external power source (not shown in the figures).

In some embodiments, the low-dropout regulator 70 is an integrated circuit voltage regulator that is able to stably output a voltage in a case where a voltage difference between an input voltage and an output voltage is small. The low-dropout regulator 70 belongs to a kind of linear direct current (DC) voltage regulator. Compared with traditional linear voltage regulators, the low-dropout regulator 70 requires a lower voltage difference between the input voltage and the output voltage.

In the actual scenario, in order to achieve power supply for the rotation detection device 20, the low-dropout regulator 70 is further disposed for power conversion, thereby providing stable DC voltage for the rotation detection device 20 and ensuring operating stability of the rotation detection device 20.

A type of the low-dropout regulator 70 is not intended to be limiting. Depending on the operating voltage of the rotation detection device 20, the low-dropout regulator 70 may vary accordingly, which is not limited in the present disclosure. In some embodiments, the low-dropout regulator 70 is a 3.3V (volt) LDO. That is, the low-dropout regulator 70 is able to output a 3.3V DC voltage.

The type of the rotation detection device 20 is not intended to be limiting. Any device can be used as the rotation detection device 20, as long as the device can detect changes in the spatial position of an object. In some embodiments, the rotation detection device 20 includes an accelerometer and/or a gyroscope.

In some embodiments, the accelerometer is also known as an acceleration sensor. The accelerometer is configured in the docking station 1, 2, 3, 4, 5 (in some embodiments, the accelerometer is disposed inside the housing 10), so that acceleration changes in three dimensions can be detected in a case where the docking station 1, 2, 3, 4, 5 is rotated. The accelerometer can sense accelerations of the docking station 1, 2, 3, 4, 5 in X, Y, and Z directions, and send these data in the form of three-dimensional spatial coordinates (i.e., the rotation state parameters) to the processing device 30. The gyroscope can detect changes in an angular velocity of the docking station 1, 2, 3, 4, 5 in real-time. That is, the gyroscope can detect rotational motion of the docking station 1, 2, 3, 4, 5. The gyroscope provides data (i.e., the rotation state parameters) on rotation direction and speed of the docking station 1, 2, 3, 4, 5, so that the processing device 30 performs display adjustment analysis for the display device 40.

In the actual scenario, the accelerometer or the gyroscope may be disposed individually as the rotation detection device 20 to detect the rotation of the docking station 1, 2, 3, 4, 5, which can effectively reduce hardware costs. In some embodiments, both the accelerometer and the gyroscope may be disposed for rotation detection of the docking station 1, 2, 3, 4, 5. By combining detection results from both the accelerometer and the gyroscope, a more precise change in the posture of the docking station 1, 2, 3, 4, 5 can be obtained, thereby improving accuracy of display adjustment for the display device 40.

In some embodiments, the rotation detection device 20 is an inertial measurement assembly.

In some embodiments, the inertial measurement assembly is a measurement device that integrates or includes the accelerometer and the gyroscope. Unlike the above embodiments where the accelerometer and the gyroscope are separately disposed in the housing 10, in some embodiments, the inertial measurement assembly that integrates or includes the accelerometer and the gyroscope is used as the rotation detection device 20, which can reduce the equipment volume to a certain extent while achieving accurate detection of the posture change.

A type of the inertial measurement assembly is not intended to be limiting. Any device can be used as the inertial measurement assembly, as long as the device integrates or includes both the accelerometer and the gyroscope. In some embodiments, the inertial measurement assembly may be a motion processing assembly with a function of a multi-axis accelerometer and a function of the gyroscope, such as MPU-6050, ICM-20602, MPU-6000, MPU-9250, etc.

In some embodiments, the rotation detection device 20 has two elements: the accelerometer and the gyroscope. Accordingly, analyzing and determining the posture change parameter by the processing device 30 based on the rotation state parameter, includes: first, analyzing based on the obtained rotation state parameter (including three-dimensional spatial acceleration data detected by the accelerometer and three-dimensional spatial angular velocity data detected by the gyroscope) to determine a time step; and then, performing integral calculation based on angular velocity data and the time step to obtain corresponding posture parameter, as well as performing integral calculation based on acceleration data and the time step to obtain corresponding posture parameter.

Then, the posture parameter is analyzed by using a fusion algorithm to finally obtain the posture change parameter. In some embodiments, the fusion algorithm may be a Kalman filter, a complementary filter algorithm, etc., which is not limited in the present disclosure.

In some embodiments, the fusion algorithm being the complementary filter algorithm is taken as an example. In a case where the docking station 4, 5 is turned on and in use, the processing device 30 first initializes the rotation detection device 20, the first communication device 50, and the second communication device 60. After initialization is successful, an initial parameter and a complementary filter coefficient alpha required for subsequent fusion algorithm are configured. Accordingly, analysis for the posture parameter using the fusion algorithm includes using the following formula:

theta=alpha*(theta+ω*Δt)*Δt)+(1−alpha)*theta_acc,
wherein theta represents the posture change parameter (which may be an angle parameter) that is obtained after performing the complementary filter algorithm; alpha represents the complementary filter coefficient, typically ranging from 0 to 1, configured to balance weights of the gyroscope and the accelerometer; * represents multiplication; w represents the angular velocity measured by the gyroscope; Δt represents the time step; and theta_acc represents an angle derived from data of the accelerometer after unit conversion using an arctangent function.

Finally, after obtaining the posture change parameter, the processing device 30 converts the posture change parameter into a display direction angle, and sends the display direction angle to the display device 40 through the display adjustment signal carrying the display direction angle, thereby enabling the display device 40 to adjust the display direction.

The type of the interface assembly 200 is not intended to be limiting, and the interface assembly 200 may vary depending on the actual usage scenario. In some embodiments, the interface assembly 200 includes at least one of a data transmission interface assembly, a video transmission interface assembly, a network interface assembly, and a charging interface assembly.

In some embodiments, the data transmission interface assembly is an interface assembly that is configured to perform data transmission. The video transmission interface assembly is an interface assembly that is configured to be connected to the display device 40 and perform video transmission. The network interface assembly is an interface assembly that is configured to be connected to a network. The charging interface assembly is an interface assembly that is configured to be connected to the power supply and perform power transmission.

In the actual scenario, the docking station 1, 2, 3, 4, 5 may be provided with one or more of the data transmission interface assembly, the video transmission interface assembly, the network interface assembly, and the charging interface assembly. The number of each interface assembly is not limited to one, which can be selected based on actual needs.

A type of the data transmission interface assembly is not intended to be limiting. The data transmission interface assembly may be Type-A, Type-C, SD/TF card slot, etc. Type-A and Type-C are mainly configured to be connected to various universal serial bus (USB) devices. Accordingly, the data transmission interface assembly includes a connected interface and a USB hub chip. The USB hub chip is connected to the main controller of the docking station 1, 2, 3, 4, 5, and the main controller may be the processing device 30 mentioned above. The video transmission interface assembly may be a high definition multimedia interface (HDMI) interface assembly. The video transmission interface assembly includes a connected interface and a video conversion chip. The video conversion chip is connected to the main controller of the docking station 1, 2, 3, 4, 5.

The network interface assembly may be a gigabit network port, which is configured to provide a wired network connection, ensuring more stable and faster network transmission. The gigabit network port includes a connected interface and an Ethernet control chip, and the Ethernet control chip is further connected to the main controller of the docking station 1, 2, 3, 4, 5. The charging interface assembly is mainly configured for charging. In some embodiments, the charging interface assembly may be a power delivery (PD) fast charging port that includes a connected interface and a PD controller. The PD controller is further connected to the main controller of the docking station 1, 2, 3, 4, 5.

In order to facilitate understanding of the technical solutions of the present disclosure, the following explanation will be provided in conjunction with more detailed embodiments.

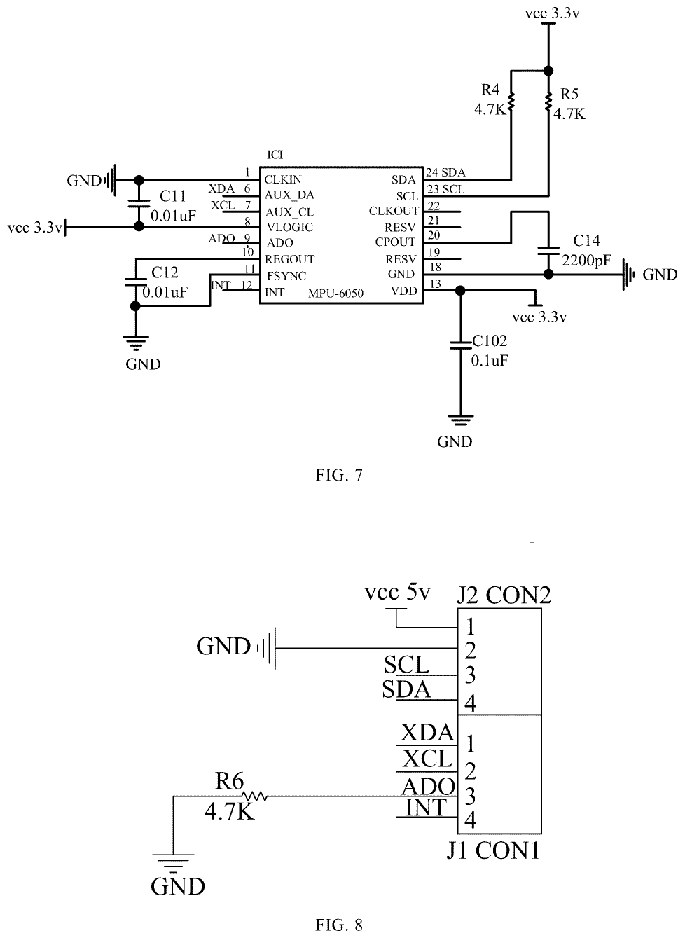

In some embodiments, the docking station 5 includes the circuit substrate 100, the interface assembly 200, the housing 10, the rotation detection device 20, the processing device 30, the display device 40, the first communication device 50, the second communication device 60, and the low-dropout regulator 70. The low-dropout regulator 70 is a 3.3V regulator, and its specific structure may be illustrated in FIG. 6. The rotation detection device 20 is the inertial measurement assembly (taking MPU-6050 as an example), and its specific structure may be illustrated in FIG. 7. The first communication device 50 is the IIC communication module, and its specific structure may be illustrated in FIG. 8. The second communication device 60 is the SPI communication module, and the display device 40 is the LCD.

The rotation detection device 20 communicates with the processing device 30 through the IIC interface (SDA, SCL) to provide real-time acceleration data and angular velocity data (i.e. the rotation state parameters). The 3.3V LDO provides operating voltage to MPU-6050. VCC and GND are connected to a 5V power supply and ground, respectively. SCL and SDA, as well as XCL and the XDA, are two IIC communication buses, respectively. ADO is a slave address setting pin of the IIC communication module, and INT is an interrupt output pin.

In this way, during using the docking station 4, 5, the processing device 30 first initializes the MPU-6050 and SPI communication modules. After successful initialization, the required initial parameter and the complementary filter coefficient alpha for operation are configured. MPU-6050 performs data collection, obtaining the acceleration data from the accelerometer and the angular velocity data (i.e. the rotation state parameter) from the gyroscope. It determines whether the data is successfully received. In some embodiments, determining whether the data is successfully received can be achieved by determining the address and verifying whether the received data is within the preset numerical range.

After determining that the data is successfully received, the processing device 30 calculates the time step Δ t and performs the integral calculation based on the acceleration data and the angular velocity data, to obtain the corresponding posture parameters. That is, the angle theta_acc is derived from the data of the accelerometer after unit conversion using the arctangent function. The angle theta_acc and the angle that is measured by the gyroscope are substituted into the formula theta=alpha*(theta+ω*Δt)+(1−alpha)*theta_acc for fusion analysis, to obtain the posture change parameter. The posture change parameter is converted into the rotation angle of the display content that needs to be adjusted by the display device 40.

Finally, the processing device 30 sends the rotation angle of the display content (carried by the display adjustment signal) to the display device 40, causing the display device 40 to change the display direction. At the same time, MPU-6050 performs next data collection. Based on the data that is collected in real-time, it returns to the operation of determine whether the data is successful received. The analysis of the posture change parameter is repeated or continuously performed, so as to achieve real-time adjustment of the display direction of the display device 40 until the docking station 4, 5 is no longer in use.

The technical features of the embodiments described above can be combined in any manner. For the sake of brevity, not all possible combinations of the technical features in the above embodiments have been described. However, as long as the combinations of these technical features are not contradictory, they should all be considered within the scope of the present disclosure.

The above embodiments only express several implementation modes of the embodiments of the present disclosure, and the descriptions thereof are more specific and detailed, but cannot be understood as limiting the scope of the disclosure. For those of ordinary skill in the art, several modifications and improvements may be made without departing from the concept of the embodiments of the present disclosure, all of which fall in the protection scope of the embodiments of the present disclosure. Thus, the protection scope of the present disclosure should be subject to the contents of the claims.

In the docking station described above, the rotation detection device, which is electrically connected to the processing device, is disposed inside the housing. The processing device is further electrically connected to the display device. During using the docking station by the user, in a case where the spatial position of the docking station changes by rotating the docking station relative to a previous time period or moment, this change can be detected by the rotation detection device. In this case, the rotation detection device collects the rotation state parameter related to the rotation of the docking station, and sends the rotation state parameter to the processing device. After receiving the rotation state parameter, the processing device analyzes to obtain the display adjustment signal. The display adjustment signal is a signal that is configured to adjust the display content of the display device in a case where the docking station is in a rotated state, making it easier for the user to view the display content. Finally, the display device adjusts the display angle of its display content according to the rotation angle of the display content carried by the display adjustment signal. Therefore, during using the docking station by the user in multiple scenarios, the display content on the docking station can adapt to common observation habits of people, facilitating the user viewing the display content. Through this solution, in a case where the user rotates the docking station from multiple angles during using the docking station, the display content on the docking station can adapt to real-time changes caused by the rotation of the docking station, thereby effectively improving convenience of information viewing during using the docking station.

1. A docking station, comprising:
a housing, wherein an outer surface of the housing defines at least one expansion port;
at least one interface assembly, disposed inside the housing, wherein there is a one-to-one correspondence between the at least one interface assembly and the at least one expansion port, and an interface end of each interface assembly extends to one corresponding expansion port;
a rotation detection device, disposed inside the housing and configured to obtain a rotation state parameter of the docking station when rotating the docking station;
a processing device, disposed inside the housing and electrically connected to the rotation detection device, wherein the processing device is configured to receive the rotation state parameter and to output a display adjustment signal, the display adjustment signal is determined based on the rotation state parameter, the display adjustment signal comprises a rotation angle of display content, and rotation angles of the display content corresponding to different rotation state parameters are different; and
a display device, disposed inside the housing, wherein a part of the display device is exposed on the outer surface of the housing, the display device is electrically connected to the processing device, and the display device is configured to adjust a display angle of the display content based on the display adjustment signal.

2. The docking station according to claim 1, wherein the docking station further comprises a first communication device, the first communication device is disposed inside the housing, and the rotation detection device is electrically connected to the processing device through the first communication device.

3. The docking station according to claim 2, wherein the first communication device is an integrated circuit bus communication module.

4. The docking station according to claim 1, wherein the docking station further comprises a second communication device, the second communication device is disposed inside the housing, and the processing device is electrically connected to the display device through the second communication device.

5. The docking station according to claim 4, wherein the second communication device is a serial peripheral interface communication module or a mobile industry processor interface communication module.

6. The docking station according to claim 1, wherein the docking station further comprises a low-dropout regulator, the low-dropout regulator is disposed inside the housing and electrically connected to the rotation detection device, and the low-dropout regulator is configured to be connected to an external power source.

7. The docking station according to claim 1, wherein the rotation detection device comprises an accelerometer and/or a gyroscope.

8. The docking station according to claim 1, wherein the rotation detection device is an inertial measurement assembly.

9. The docking station according to claim 1, wherein the rotation angle of the display content is greater than 0 degrees and less than or equal to 360 degrees.

10. The docking station according to claim 1, wherein the interface assembly comprises at least one of a data transmission interface assembly, a video transmission interface assembly, a network interface assembly, and a charging interface assembly.

11. A docking station, comprising:
a housing;
at least one interface assembly, disposed inside the housing, wherein an interface end of each interface assembly extends to an expansion port of the housing;
a rotation detection device, disposed inside the housing and configured to obtain a rotation state parameter of the docking station when rotating the docking station;
a processing device, disposed inside the housing and electrically connected to the rotation detection device, wherein the processing device is configured to receive the rotation state parameter and to output a display adjustment signal, the display adjustment signal is determined based on the rotation state parameter, the display adjustment signal comprises a rotation angle of display content, and rotation angles of the display content corresponding to different rotation state parameters are different; and
a display device, disposed inside the housing, wherein a part of the display device is exposed on an outer surface of the housing, the display device is electrically connected to the processing device, and the display device is configured to adjust a display angle of the display content based on the display adjustment signal.

12. The docking station according to claim 11, wherein the docking station further comprises a first communication device, the first communication device is disposed inside the housing, and the rotation detection device is electrically connected to the processing device through the first communication device.

13. The docking station according to claim 12, wherein the first communication device is an integrated circuit bus communication module.

14. The docking station according to claim 11, wherein the docking station further comprises a second communication device, the second communication device is disposed inside the housing, and the processing device is electrically connected to the display device through the second communication device.

15. The docking station according to claim 14, wherein the second communication device is a serial peripheral interface communication module or a mobile industry processor interface communication module.

16. The docking station according to claim 11, wherein the docking station further comprises a low-dropout regulator, the low-dropout regulator is disposed inside the housing and electrically connected to the rotation detection device, and the low-dropout regulator is configured to be connected to an external power source.

17. The docking station according to claim 11, wherein the rotation detection device comprises an accelerometer and/or a gyroscope.

18. The docking station according to claim 11, wherein the rotation detection device is an inertial measurement assembly.

19. The docking station according to claim 11, wherein the rotation angle of the display content is greater than 0 degrees and less than or equal to 360 degrees.

20. The docking station according to claim 11, wherein the interface assembly comprises at least one of a data transmission interface assembly, a video transmission interface assembly, a network interface assembly, and a charging interface assembly.
